(19) United States
(12) Patent Application Publication
(10) Pub. No.: US 2019/0129236 A1
(43) Pub. Date: May 2, 2019

(54) DISPLAY DEVICE

(71) Applicant: SAMSUNG DISPLAY CO., LTD., Yongin-si (KR)

(72) Inventors: Sowoon KIM, Suwon-si (KR); Wooil PARK, Yongin-si (KR); Youngmin AHN, Cheonan-si (KR); Donghun LEE, Asan-si (KR); Hyongdo CHOI, Yongin-si (KR)

(21) Appl. No.: 16/177,567

(22) Filed: Nov. 1, 2018

(30) Foreign Application Priority Data
Nov. 1, 2017 (KR) 10-2017-0144478

(51) Int. Cl. G02F 1/1333; F21V 8/00; G02F 1/1335

(52) U.S. Cl. CPC G02F 1/133308; G02B 6/0055; G02F 1/133528; G02F 1/133608; G02F 2202/28; G02B 6/0073

(57) ABSTRACT

A display device includes: a display panel which displays an image, the display panel including first, second, third and fourth side edge portions which respectively meet each other at corners of the display panel; a mold frame which is attachable to and detachable from the display panel, the mold frame including a plurality of bent frames which are attachable and detachable from each other, each bent frame commonly overlapped by two side edge portions of the display panel which meet each other at a corner thereof; and an adhesive member disposed commonly between the two side edge portions of the display panel which meet each other at the corner thereof and the bent frame of the mold frame overlapped thereby, to attach the display panel and the mold frame to each other.

This application claims priority under 35 U.S.C. § 119 to Korean Patent Application No. 10-2017-0144478, filed on Nov. 1, 2017, and all the benefits accruing therefrom under 35 U.S.C. § 119, the disclosure of which is incorporated by reference herein in its entirety.

### BACKGROUND

### 1. Field

Embodiments of the invention relate to a display device.

### 2. Description of the Related Art

Display devices may be classified into liquid crystal display (“LCD”) devices, organic light emitting diode (“OLED”) display devices, plasma display panel (“PDP”) devices, electrophoretic display devices and the like based on a light emitting scheme thereof

Display devices may include a display panel and a mold frame for supporting and fastening the display panel. In such a case, in order to reduce the thickness of the display devices, the display panel is directly attached onto the mold frame using an adhesive member. For example, an adhesive member having a quadrangular loop shape may be used for attaching an edge of a back surface of the display panel onto the mold frame.

### SUMMARY

Embodiments of the invention may be directed to a display device capable of substantially preventing a display panel from being damaged during reworking.

According to an exemplary embodiment, a display device includes: a display panel which displays an image, the display panel including first, second, third and fourth side edge portions which respectively meet each other at corners of the display panel; a mold frame which is attachable to and detachable from the display panel, the mold frame including a plurality of bent frames which are attachable and detachable from each other, each bent frame commonly overlapped by two side edge portions of the display panel which meet each other at a corner thereof; and an adhesive member disposed commonly between the two side edge portions of the display panel which meet each other at the corner thereof and the bent frame of the mold frame overlapped thereby, to attach the display panel and the mold frame to each other.

In a top plan view, each bent frame commonly overlapped by the two side edge portions of the display panel has an “L” shape.

In cross-section, each bent frame commonly overlapped by the two side edge portions of the display panel includes: a support portion which is commonly overlapped by and supports thereon the two side edge portions of the display panel and a side surface portion bent from the support portion to face end surfaces of the two side edge portions of the display panel.

The adhesive member may be disposed commonly between the two side edge portions and the support portion overlapped thereby and may directly contact the two side edge portions and the support portion overlapped thereby.

First to fourth bent frames may be respectively commonly overlapped by the two side edge portions of the display panel which meet each other at first to fourth corners of the display panel. The adhesive member may be provided in plurality separable from each other, including first to fourth adhesive members respectively commonly between the two side edge portions of the display panel which meet each other at the first to fourth corners of the display panel and the first to fourth bent frames commonly overlapped thereby.

In a top plan view, a planar shape of the first to fourth adhesive members may be respectively the same as a planar shape of the support portions of the first to fourth bent frames.

The adhesive member commonly between the two side edge portions of the display panel which meet each other at the corner thereof and the bent frame of the mold frame overlapped thereby, may be a double-sided tape.

At least one surface of the double-sided tape may include at least one of an acrylic resin, an epoxy resin, a fluoro-resin and a polytetrafluoroethylene resin.

A first bent frame and a second bent frame of the mold frame may be adjacent to each other, the first bent frame may include a projecting portion which projects toward the second bent frame, and the second bent frame may include a recessed portion into which the projecting portion is inserted.

The projecting portion may have a dovetail cross-sectional shape.

A first bent frame and a second bent frame of the mold frame may be adjacent to each other along a same side edge portion of the display panel. The mold frame may further include a connection frame between the first and second bent frame adjacent to each other to connect the first and second bent frames to each other at the same side edge portion of the display panel.

In a top plan view, a length of the connection frame may extend in a single direction along the same side edge portion of the display panel.

In cross-section, each of the first and second bent frames and the connection frame therebetween may include a support portion which supports the display panel thereon and a side surface portion bent from the support portion to face an end surface of the display panel.

The adhesive member may be commonly disposed between the display panel and the support portions of the first and second bent frames and the connection frame therebetween and may directly contact the display panel and the support portions of the first and second bent frames and the connection frame therebetween.

The adhesive member may be provided in plurality separable from each other, including: a first adhesive member between the display panel and the first bent frame, a second adhesive member between the display panel and the second bent frame, and a third adhesive member between the display panel and the connection frame.

In a top plan view, a planar shape of each of the first and second adhesive members may be respectively the same as a planar shape of the support portions of the first and second bent frames, and a planar shape of the third adhesive member may be the same as a planar shape of the support portion of the connection frame between the first and second bent frames.

One of the first bent frame and the second bent frame may include a projecting portion which projects toward the connection frame, and the connection frame may include a recessed portion into which the projecting portion is inserted.

The projecting portion may have a dovetail cross-sectional shape.

The connection frame between the first and second bent frames adjacent to each other along the same side edge portion of the display panel may include a projecting portion which projects toward one of the first bent frame and the second bent frame, and the one of the first bent frame and the second bent frame may include a recessed portion into which the projecting portion is inserted.

The display device may further include disposed within the mold frame which is attachable to and detachable from the display panel: a light source which emits a light to the display panel to display the image; a light guide plate which guides the light emitted from the light source to the display panel; and an optical sheet between the light guide plate and the display panel.

The foregoing is illustrative only and is not intended to be in any way limiting. In addition to the illustrative exemplary embodiments and features described above, further exemplary embodiments and features will become apparent by reference to the drawings and the following detailed description.

### BRIEF DESCRIPTION OF THE DRAWINGS

A more complete appreciation of the invention will become more apparent by describing in detail exemplary embodiments thereof with reference to the accompanying drawings, where:

FIG. 1 is an exploded perspective view schematically illustrating an exemplary embodiment of a display device according to the invention;

FIG. 2 is a cross-sectional view taken along ‘line A-A’ in FIG. 1;

FIG. 3 is an exploded perspective view illustrating an exemplary embodiment of a display panel, a mold frame and an adhesive member of the display device of FIG. 1;

FIG. 4 is an exploded perspective view illustrating another exemplary embodiment of a display panel, a mold frame and an adhesive member of a display device according to the invention;

FIG. 5 is an exploded perspective view illustrating still another exemplary of a display panel, a mold frame and an adhesive member of a display device according to the invention;

FIG. 6 is a cross-sectional view illustrating an exemplary embodiment of a mold frame of a display device according to the invention;

FIG. 7 is a perspective view illustrating an exemplary embodiment of a projecting portion and a recessed portion of a mold frame of a display device according to the invention;

FIG. 8 is a perspective view illustrating another exemplary embodiment of a projecting portion and a recessed portion of a mold frame of a display device according to the invention;

FIGS. 9A and 9B are cross-sectional views illustrating still other exemplary embodiments of a mold frame of a display device according to the invention; and

FIG. 10 is an exploded perspective view illustrating yet another exemplary embodiment of a display panel, a mold frame and an adhesive member of a display device according to the invention.

### DETAILED DESCRIPTION

Exemplary embodiments will now be described more fully hereinafter with reference to the accompanying drawings. Although the invention may be modified in various manners and have several exemplary embodiments, exemplary embodiments are illustrated in the accompanying drawings and will be mainly described in the specification. However, the scope of the invention is not limited to the exemplary embodiments and should be construed as including all the changes, equivalents and substitutions included in the spirit and scope of the invention.

In the drawings, thicknesses of a plurality of layers and areas are illustrated in an enlarged manner for clarity and ease of description thereof. When a layer, area, or plate is referred to as being related to another element such as being “on” another layer, area, or plate, it may be directly on the other layer, area, or plate, or intervening layers, areas, or plates may be present therebetween. Conversely, when a layer, area, or plate is referred to as being related to another element such as being “directly on” another layer, area, or plate, intervening layers, areas, or plates are absent therebetween. Further when a layer, area, or plate is referred to as being related to another element such as being “below” another layer, area, or plate, it may be directly below the other layer, area, or plate, or intervening layers, areas, or plates may be present therebetween. Conversely, when a layer, area, or plate is referred to as being related to another element such as being “directly below” another layer, area, or plate, intervening layers, areas, or plates are absent therebetween.

The spatially relative terms “below,” “beneath,” “lower,” “above,” “upper” and the like, may be used herein for ease of description to describe the relations between one element or component and another element or component as illustrated in the drawings. It will be understood that the spatially relative terms are intended to encompass different orientations of the device in use or operation, in addition to the orientation depicted in the drawings. For example, in the case where a device illustrated in the drawing is turned over, the device positioned “below” or “beneath” another device may be placed “above” another device. Accordingly, the illustrative term “below” may include both the lower and upper positions. The device may also be oriented in the other direction and thus the spatially relative terms may be interpreted differently depending on the orientations.

Throughout the specification, when an element is referred to as being “connected” to another element, the element is “physically connected” of “mechanically connected” to the other element, or “electrically connected” to the other element with one or more intervening elements interposed therebetween. The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises,” “including,” “includes” and/or “including,” when used in this specification, specify the presence of stated features, integers, steps, operations, elements and/or components, but do not preclude the presence or addition of one or more other features, integers, steps, operations, elements, components and/or groups thereof.

It will be understood that, although the terms “first,” “second,” “third,” and the like may be used herein to describe various elements, these elements should not be limited by these terms. These terms are only used to distinguish one element from another element. Thus, “a first element” discussed below could be termed “a second element” or “a third element,” and “a second element” and “a third element” may be termed likewise without departing from the teachings herein.

“About” or “approximately” as used herein is inclusive of the stated value and means within an acceptable range of variation for the particular value as determined by one of ordinary skill in the art, considering the measurement in question and the error associated with measurement of the particular quantity (i.e., the limitations of the measurement system). For example, “about” may mean within one or more standard variations, or within ±30%, 20%, 10% or 5% of the stated value.

Unless otherwise defined, all terms used herein (including technical and scientific terms) have the same meaning as commonly understood by those skilled in the art to which this invention pertains. It will be further understood that terms, such as those defined in commonly used dictionaries, should be interpreted as having a meaning that is consistent with their meaning in the context of the relevant art and will not be interpreted in an ideal or excessively formal sense unless clearly defined in the present specification.

Some of the parts which are not associated with the description may not be provided in order to specifically describe embodiments of the invention and like reference numerals refer to like elements throughout the specification.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

When defects are identified after a process of attaching a display panel and a mold frame in forming a display device, the defects may be dealt with by reworking. However, when the mold frame once attached to the display panel such as by an adhesive member is detached from the display panel for the rework, the display panel may be damaged by a relatively strong adhesive force of the adhesive member. Consequently, the reworking time undesirably increases so as not to damage the display panels or the damaged display panels are be discarded to undesirably increase costs of manufacturing a display device.

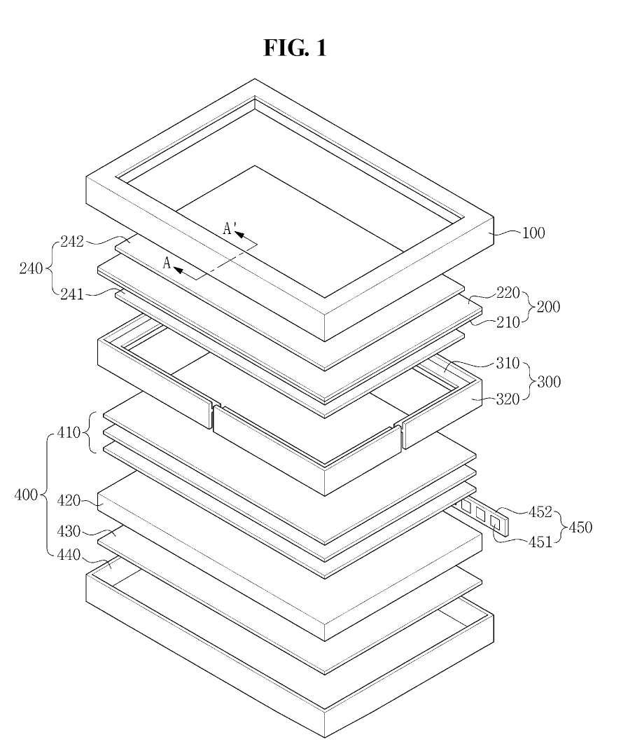

Hereinafter, an exemplary embodiment will be described in detail with reference to FIGS. 1, 2 and 3.

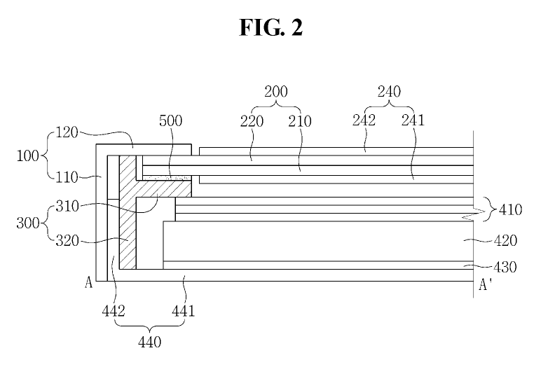

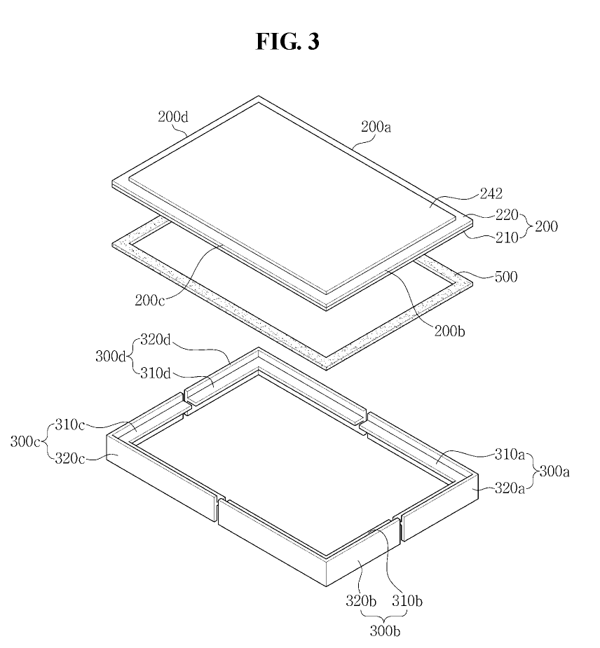

FIG. 1 is an exploded perspective view schematically illustrating an exemplary embodiment of a display device according to the invention, FIG. 2 is a cross-sectional view taken along line A-A′ in FIG. 1 and FIG. 3 is an exploded perspective view illustrating an exemplary embodiment of a display panel, a mold frame and an adhesive member of the display panel of FIG. 1.

Referring to FIGS. 1, 2 and 3, a display device according to an exemplary embodiment includes a display panel 200 displaying images with light, a backlight assembly 400 which generates and provides the light to the display panel 200 for displaying the images, an upper frame 100 provided in a form which surrounds the display panel 200 and a mold frame 300 on which the upper frame 100 and the display panel 200 are mounted.

The upper frame 100 is coupled to a lower frame 440 in order to cover an edge of the display panel 200 mounted on the mold frame 300. The upper frame 100 has an open window at a center portion thereof through which a display surface or display area of the display panel 200 is exposed to outside the display device. The upper frame 100 may be disposed to cover or face a side surface and an edge of an upper surface of the display panel 200.

The upper frame 100 includes an edge portion 110 and an upper surface portion 120. The edge portion 110 is coupled to the lower frame 440 and covers the side surface of the display panel 200. The upper surface portion 120 is bent from the edge portion 110 to extend therefrom and covers the edge of upper surface of the display panel 200. One of the edge portion 110 and the upper surface portion 120 may extend bent to define the other one of the edge portion 110 and the upper surface portion 120. The upper frame 100 fastens the edge of the upper surface of the display panel 200 within the display device, thereby substantially preventing the display panel 200 from being separated from the backlight assembly 400.

The upper frame 100 may include a relatively rigid metal material such as stainless steel and/or a material having good heat dissipation characteristics such as aluminum or an aluminum alloy. In an exemplary embodiment of manufacturing a display device, the upper frame 100 may be formed through a press molding process or the like to have a predetermined curvature.

The upper frame 100 may be coupled to the lower frame 440 such as by using a hook and/or a screw. However, exemplary embodiments are not limited thereto, and coupling of the upper frame 100 and the lower frame 440 may be modified in various forms. In addition, the upper frame 100 may be omitted.

The display panel 200 generates and displays images with light. The display panel 200 is a light-receiving type display panel and examples of the display panel 200 may include a liquid crystal display (“LCD”) panel, an electro-wetting display panel, an electrophoretic display panel, a microelectromechanical system (“MEMS”) display panel, or the like. In another embodiment, the display panel 200 may be a light-generating (e.g., self-emissive) type display panel. Herein, an LCD panel is to be described as the display panel 200 according to an exemplary embodiment by way of example. In addition, although not illustrated, the display panel 200 may be a flexible display panel which may be bent in at least one direction.

The display panel 200 may be provided in a quadrangular plate shape having two pairs of sides respectively parallel to each other. The display panel 200 according to an exemplary embodiment may have a quadrangular shape having a pair of relatively long sides and a pair of relatively short sides. In an exemplary embodiment, for example, as illustrated in FIG. 3, the display panel 200 may include a first side surface portion 200a at a long side, a second side surface portion 200b at a short side, a third side surface portion 200c at a long side and a fourth side surface portion 200d at a short side. The first, second, third and fourth side surface portions 200a, 200b, 200c and 200d may be connected to each other to define the display panel 200 of an overall quadrangle shape. The side surface portions are respectively at edge (or peripheral) portions of the display panel 200.

The display device and components thereof may be disposed in a plane defined by first and second directions crossing each other. Referring to FIG. 1 and FIG. 3, for example, the first and second directions may be taken along the relatively long and the relatively short sides described above. A thickness of the display device may be taken in a third direction which crosses each of the first and second directions. Referring to FIG. 2, for example, a vertical direction may define the thickness direction, while the horizontal direction may define the first and/or second directions.

The display panel 200 includes a first (display) substrate 210 and a second (display) substrate 220 which opposes the first substrate 210. Further, although not illustrated, the display panel 200 may further include an optical control or optical transmittance layer such as a liquid crystal layer disposed or formed between the first substrate 210 and the second substrate 220.

The display panel 200 includes, in a plane, a display area at which images are displayed and a non-display area which surrounds the display area and at which images are not displayed. The non-display area may be covered by the upper frame 100. However, exemplary embodiments are not limited thereto and an entire top surface of the display panel 200 may be the display area at which images are displayed and the upper frame may be omitted.

Although not illustrated, one of the first substrate 210 and the second substrate 220 may include a plurality of pixel electrodes and a plurality of thin film transistors which are electrically connected to the pixel electrodes in one-to-one correspondence. A first signal line such as a data line is connected to a source electrode of the thin film transistor, a second signal line such as a gate line is connected to a gate electrode of the thin film transistor and a pixel electrode is connected to a drain electrode of the thin film transistor. Each thin film transistor switches a driving signal provided to each corresponding one of the pixel electrodes.

One of the first substrate 210 and the second substrate 220 may include a common electrode and a color filter for controlling arrangement of material within the optical control or optical transmittance layer such as liquid crystals together with the pixel electrodes to form an electric field. In addition, one of the first substrate 210 and the second substrate 220 may further include a color filter. The color filter may include red, green and blue color filters.

The liquid crystal layer is interposed between the first substrate 210 and the second substrate 220 and is rearranged by an electric field formed between the pixel electrode and the common electrode. Such a rearranged liquid crystal layer adjusts a transmittance of the light emitted from the backlight assembly 400 and the thus adjusted light passes through the color filter to display images to outside the display panel 200.

In addition, although not illustrated, the display panel 200 may further include a circuit board and/or a driving chip. The circuit board may apply a driving signal to various signal lines disposed on the first substrate 210 and the driving chip may generate various driving signals for driving the display panel 200.

A polarizer (member) 240 is disposed at the display panel 200 and includes a first polarizer 241 and a second polarizer 242. The first polarizer 241 and the second polarizer 242 are disposed on respective surfaces of the first substrate 210 and the second substrate 220 that are opposite to surfaces of the first substrate 210 and the second substrate 220 facing each other, respectively. That is, the first polarizer 241 may be attached to an outer side of the first substrate 210 and the second polarizer 242 may be attached to an outer side of the second substrate 220.

A transmission axis of the first polarizer 241 may be substantially perpendicular to a transmission axis of the second polarizer 242. The first polarizer 241 may pass only specific polarized light among light output from the backlight assembly 400 and may absorb or block remaining light therefrom. The second polarizer 242 may pass only specific polarized light among light externally incident thereto and may absorb or block remaining light incident thereto.

The mold frame 300 is coupled to the lower frame 440 and supports the display panel 200. The mold frame 300 includes a support portion 310 for supporting the display panel 200 and a side surface portion 320 which is bent from the support portion 310. As illustrated in FIG. 2, the mold frame 300 according to an exemplary embodiment may have a cross-sectional shape of “T”. One of the support portion 310 and the side surface portion 320 may extend bent to define the other one of the support portion 310 and the side surface portion 320. In addition, the side surface portion 320 may be disposed or formed to have a length larger than a length of a side wall portion 442 of the lower frame 440 to be described below. However, exemplary embodiments are not limited thereto. In an alternative exemplary embodiment, the mold frame 300 may have a cross-sectional shape of “L,” and the side surface portion 320 may be disposed or formed to have a length smaller than that of the side wall portion 442 of the lower frame 440.

The mold frame 300 may include a flexible material such as a plastic material so as to substantially prevent breakage of the display panel 200 supported thereon. In addition, the mold frame 300 may include a metal material so as to substantially ensure rigidity of the display device and fastening force with the lower frame 440. In the case where the mold frame 300 includes a metal material, the side surface portion 320 may have a thickness in a range from about 0.1 millimeter (mm) to about 0.3 mm so as to be deformable such as being curved. However, exemplary embodiments are not limited thereto and the thickness of the side surface portion 320 may be variously set so that both ductility and rigidity of the side surface portion 320 may be ensured. A thickness of the side surface portion 320 of the mold frame 300 may be taken in the horizontal direction of FIG. 2, for example, while a length thereof extends in a direction into the page view of FIG. 2.

The mold frame 300 is lengthwise provided along an edge of the display panel 200 and supports the display panel 200 from below the display panel 200. The mold frame 300 may have a quadrangular loop shape corresponding to four sides of the display panel 200. In an exemplary embodiment, for example, as illustrated in FIG. 3, the mold frame 300 may have a quadrangular loop shape overlapping the first, second, third and fourth side surface portions 200a, 200b, 200c and 200d of the display panel 200.

The mold frame 300 according to an exemplary embodiment includes a plurality of divided bent frames 300a, 300b, 300c and 300d. More specifically, as illustrated in FIG. 3, the mold frame 300 may include a first bent frame 300a, a second bent frame 300b, a third bent frame 300c and a fourth bent frame 300d.

The first bent frame 300a overlaps a part of the first side surface portion 200a and a part of the second side surface portion 200b of the display panel 200 which are adjacent to each other, and has a bent shape at an area overlapping a boundary (e.g., corner formed) between the first side surface portion 200a and the second side surface portion 200b. The second bent frame 300b overlaps a part of the second side surface portion 200b and a part of the third side surface portion 200c of the display panel 200, and has a bent shape at an area overlapping a boundary between the second side surface portion 200b and the third side surface portion 200c. The third bent frame 300c overlaps a part of the third side surface portion 200c and a part of the fourth side surface portion 200d of the display panel 200, and has a bent shape at an area overlapping a boundary between the third side surface portion 200c and the fourth side surface portion 200d.

The fourth bent frame 300d overlaps a part of the fourth side surface portion 200d and a part of the first side surface portion 200a of the display panel 200, and has a bent shape at an area overlapping a boundary between the fourth side surface portion 200d and the first side surface portion 200a.

That is, each of the first, second, third and fourth bent frames 300a, 300b, 300c and 300d has a shape of “L” in a plane. In addition, the first, second, third and fourth bent frames 300a, 300b, 300c and 300d include support portions 310a, 310b, 310c and 310d on which is supported the display panel 200, and side surface portions 320a, 320b, 320c and 320d bent from the support portions 310a, 310b, 310c and 310d, respectively. The supporting portions of adjacent bent frames joined to each other may be disposed coplanar with each other to support the display panel 200 thereon.

As described above, as the mold frame 300 according to an exemplary embodiment includes the first, second, third and fourth bent frames 300a, 300b, 300c and 300d which are divided and separable from each other, a reworking time may be substantially minimized and damage to the display panel 200 may be substantially prevented during a rework process which is performed due to defects, which will be described in detail below.

The backlight assembly 400 includes an optical sheet (member) 410, a light guide plate 420, a reflective sheet 430, the lower frame 440 and a light source unit 450.

The light source unit 450 includes a light source 451 and a circuit board 452 on which the light source 451 is disposed. The light source unit 450 may be disposed at an edge portion or a light incident side surface of the light guide plate 420. That is, the light source unit 450 may generate light and emit the light to the edge portion or the light incident side surface of the light guide plate 420.

The light source 451 may include at least one light emitting diode (“LED”) chip and a package for accommodating the LED chip. The light source 451 may have an emission surface in a direction in which the light guide plate 420 is disposed. The light emitted from the light source 451 may be a blue light.

The circuit board 452 may include, for example, a printed circuit board (“PCB”) or a metal PCB.

Such a light source unit 450 may be disposed or formed at one side surface, at each of opposite side surfaces or at all four side surfaces of the light guide plate 420, and/or at least one corner portion of the light guide plate 420 in consideration of the size, luminance uniformity or the like of the display panel 200.

Although not illustrated, a heat dissipation member may be disposed between the light source unit 450 and the lower frame 440. The heat dissipation member dissipates heat generated in the light source unit 450 to be ultimately transferred away from the light source unit 450 such as to outside the display device. In the case where the light source unit 450 is arranged to have a bar or line shape extended along one side surface of the lower frame 440, the heat dissipation member may also be provided as a metal frame having a bar or line shape. As such, the heat dissipation member may have various shapes according to the shape of the light source unit 450.

The light guide plate 420 receives the light emitted from the light source 451 through the incident side surface thereof, guides the light toward the emission surface thereof facing the display panel 200 and emits the light through the emission surface toward the display panel 200. A rear surface of the light guide plate 420 is opposite to the emission surface thereof, and side surfaces of the light guide plate 420 each connect the emission and rear surfaces to each other. One or more of the side surfaces may define the incident side surface of the light guide plate 420. The light guide plate 420 uniformly supplies the light provided from the light source unit 450 to the display panel 200. The light guide plate 420 is disposed in the vicinity of the light source unit 450 and is accommodated in the lower frame 440. The light guide plate 420 may be disposed or formed in a quadrangular plate shape similar to the display panel 200, for example. However, exemplary embodiments are not limited thereto. In the case where the light source 451 such as an LED is used, the light guide plate 420 may include a predetermined groove and/or projecting portions at which the LED is disposed depending on the position of the light source 451.

Although the light guide plate 420 has been described as a plate for convenience of explanation, the light guide plate 420 may be formed as a sheet or a film to slim down the display device. That is, the light guide plate 420 is to be understood as having a form including both a plate and a film for guiding light.

The light guide plate 420 may include a light-transmitting material, such as an acrylic resin, e.g., polymethylmethacrylate (“PMMA”) and polycarbonate (“PC”), to allow light to be efficiently guided.

Although not illustrated, a wavelength conversion (member) portion may be disposed between the light guide plate 420 and the light source unit 450, such as between an incident side surface of the light guide plate 420 and the light source unit 450. The wavelength conversion portion may include a material that changes the wavelength of light incident thereto. In an exemplary embodiment, for example, the wavelength conversion portion may convert a wavelength of a blue light emitted from a blue LED light source into a white light which is provided to the light guide plate 420.

The optical sheet 410 is disposed between the light guide plate 420 and the display panel 200 and is configured to diffuse and collimate the light guided thereto from the light guide plate 420. The optical sheet 410 may include plurality of individual sheets such as a diffusion sheet, a prism sheet, a protective sheet, or the like.

The diffusion sheet may diffuse the light emitted from the light guide plate 420 and substantially prevent the light from being partially concentrated.

The prism sheet may include prisms, each having a triangular cross-section, which is disposed or formed at one surface of the prism sheet in a predetermined arrangement. The prism sheet may be disposed on the diffusion sheet and serve to collimate the light diffused by the diffusion sheet in a direction perpendicular to the display panel 200.

The protective sheet may be disposed or formed on the prism sheet and serve to protect a surface of the prism sheet and diffuse the light to achieve uniform distribution of light incident to the display panel 200.

The reflective sheet 430 is disposed between the light guide plate 420 and the lower frame 440. The reflective sheet 430 reflects the light guided downwardly and emitted through a rear surface of the light guide plate 420 opposite to the emission surface thereof, to be directed toward the display panel 200, thus improving luminous efficiency.

The reflective sheet 430 may include, for example, polyethylene terephthalate (“PET”), thus having reflective characteristics. In an embodiment, one surface of the reflective sheet 430 may be coated with a diffusion layer including, for example, titanium dioxide to impart reflective characteristics to the reflective sheet 430.

In an exemplary embodiment, the reflective sheet 430 may include a material including a metal such as silver (Ag).

The lower frame 440 accommodates therein the reflective sheet 430 and the light guide plate 420. The lower frame 440 includes a bottom portion 441 and the side wall portion 442 which is bent from the bottom portion 441. The bottom portion 441 of the lower frame 440 is substantially parallel to the light guide plate 420. The lower frame 440 may include a relatively rigid metal material such as stainless steel and/or a material having good heat dissipation properties such as aluminum or an aluminum alloy. The lower frame 440 according to an exemplary embodiment maintains the overall framework of the display device and protects various components accommodated therein.

The display device according to an exemplary embodiment further includes an adhesive member 500 between the mold frame 300 and the display panel 200 so as to fasten the display panel 200 on the mold frame 300 to each other within the display device. The mold frame 300 is attachable and detachable from the display panel 200 via the adhesive member 500 therebetween. Each individual frame of the overall mold frame 300 is removably attached to a corresponding edge portion of the display panel 200 via the adhesive member 500.

The adhesive member 500 according to an exemplary embodiment may be a double-sided tape. The adhesive member 500 may have an adhesive force in a range from about 1 kilogram-force per square centimeter (kgf/cm²) to about 10 kgf/cm², for example. In such an exemplary embodiment, at least one surface of the double-sided tape may include at least one of an acrylic resin, an epoxy resin, a fluoro-resin and a polytetrafluoroethylene (“PTFE”) resin material such as Teflon™ resin. However, exemplary embodiments are not limited thereto, and the adhesive member 500 may be a cured adhesive such as obtained by curing a liquid adhesive material.

The adhesive member 500 is disposed on the support portion 310 of the mold frame 300 and fastens the display panel 200 on the mold frame 300. That is, a first surface of the adhesive member 500 is attached to the respective support portions 310a, 310b, 310c and 310d of the first, second, third and fourth bent frames 300a, 300b, 300c and 300d and a second surface of the adhesive member 500 opposite to the first surface thereof is attached to the first substrate 210 of the display panel 200. A single one adhesive member 500 may be common to each of the first, second, third and fourth bent frames 300a, 300b, 300c and 300d, without being limited thereto.

Problems of various defects, e.g., poor assembling between the display panel 200 and the mold frame 300, may occur during the manufacturing process of the display device. In such a case, a rework process is performed to solve the defects. The rework process may include a separation process in which the mold frame 300 is separated from the display panel 200. In such an exemplary embodiment, when the mold frame 300 is forcibly detached from the display panel 200 by applying a force to the display panel 200 and/or the mold frame 300, the display panel 200 may be damaged by the relatively strong adhesive force of the adhesive member 500 with respect to components attached thereto by the adhesive force. In addition, in the case where an additional process such as applying heat is performed in order to substantially prevent the display panel 200 from being damaged, a reworking time may disadvantageously increase.

According to an exemplary embodiment, however, as the mold frame 300 includes first, second, third and fourth bent frames 300a, 300b, 300c and 300d which are divided to be separable from each other, the above-described problems may be substantially prevented.

In specific, dissimilar to a conventional structure in which the display device includes a single one mold frame member, an overlap area between the display panel 200 and the single mold frame is relatively large, such that in order to detach the display panel 200 from the single mold frame, a relatively large force is applied thereto. On the other hand, in one or more exemplary embodiment of the invention, when the display device includes the first, second, third and fourth bent frames 300a, 300b, 300c and 300d which are divided and separable from each other, a contact area between the display panel 200 and each of the first, second, third and fourth bent frames 300a, 300b, 300c and 300d is relatively small, such that each of the first, second, third and fourth bent frames 300a, 300b, 300c and 300d may be relatively easily separated from the display panel 200 with a relatively smaller force. Accordingly, each of the first, second, third and fourth bent frames 300a, 300b, 300c and 300d may be relatively easily separated from the display panel 200 without an additional process, e.g., heat application, for substantially preventing damage to the display panel 200.

In other words, since the mold frame 300 according to one or more exemplary embodiment includes the first, second, third and fourth bent frames 300a, 300b, 300c and 300d which are divided and separable from each other, the reworking time may be substantially minimized and the display panel 200 may be substantially prevented from being damaged due to the rework process.

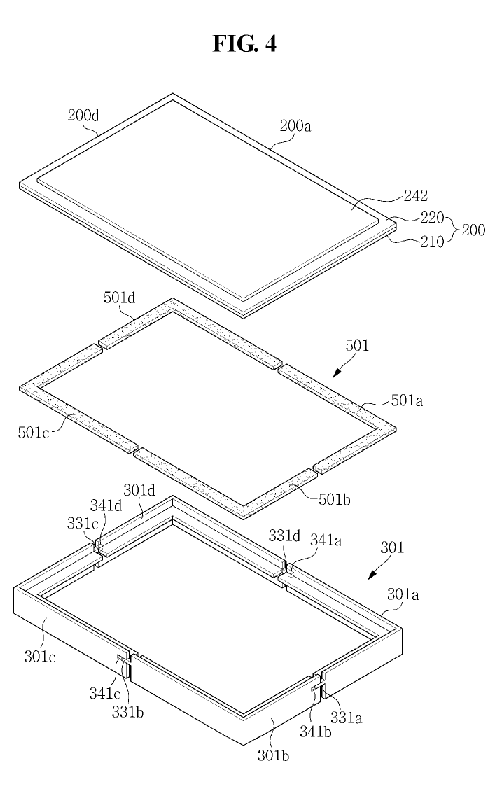

Hereinafter, another exemplary embodiment will be described with reference to FIG. 4. The description of the same configurations as those of a previous exemplary embodiment will be omitted for convenience of explanation.

FIG. 4 is an exploded perspective view illustrating another exemplary embodiment of a display panel, a mold frame and an adhesive member of a display device according to the invention.

Referring to FIG. 4, a mold frame 301 according to another exemplary embodiment includes first, second, third and fourth bent frames 301a, 301b, 301c and 301d. The first, second, third and fourth bent frames 301a, 301b, 301c and 301d include projecting portions 331a, 331b, 331c and 331d and recessed portions 341a, 341b, 341c and 341d, respectively.

In an exemplary embodiment, for example, the first bent frame 301a includes the projecting portion 331a projecting toward the second bent frame 301b adjacent to the first bent frame 301a, and the second bent frame 301b includes the recessed portion 341b to which the projecting portion 331a of the first bent frame 301a is inserted. The second bent frame 301b includes the projecting portion 331b projecting toward the third bent frame 301c adjacent to the second bent frame 301b, and the third bent frame 301b includes the recessed portion 341c to which the projecting portion 331b of the second bent frame 301b is inserted. The third bent frame 301c includes the projecting portion 331c projecting toward the fourth bent frame 301d adjacent to the third bent frame 301c, and the fourth bent frame 301d includes the recessed portion 341d to which the projecting portion 331c of the third bent frame 301c is inserted. The fourth bent frame 301d includes the projecting portion 331d projecting toward the first bent frame 301a adjacent to the fourth bent frame 301d, and the first bent frame 301a includes the recessed portion 341a to which the projecting portion 331d of the fourth bent frame 301d is inserted.

In such an exemplary embodiment, each of the projecting portions 331a, 331b, 331c and 331d are depicted as having a quadrangular prism shape. However, exemplary embodiments are not limited thereto, and the projecting portions 331a, 331b, 331c and 331d may have various shapes. In an exemplary embodiment, for example, each of the projecting portions 331a, 331b, 331c and 331d may have a dovetail cross-sectional shape.

As such, as the projecting portions 331a, 331b, 331c and 331d of the first, second, third and fourth bent frames 301a, 301b, 301c and 301d are inserted into each corresponding one of the recessed portions 341a, 341b, 341c and 341d of the first, second, third and fourth bent frames 301a, 301b, 301c and 301d, coupling force between the first, second, third and fourth bent frames 301a, 301b, 301c and 301d may be improved.

In addition, an adhesive member 501 according to another exemplary embodiment includes a plurality of divided adhesive members 501a, 501b, 501c and 501d corresponding to the first, second, third and fourth bent frames 301a, 301b, 301c and 301d, respectively. That is, each of the first, second, third and fourth adhesive members 501a, 501b, 501c and 501d has a shape of “L” on a plane.

As such, as the display device includes the plurality of adhesive members 501a, 501b, 501c and 501d respectively corresponding to the first, second, third and fourth bent frames 301a, 301b, 301c and 301d, the mold frame 301 may be relatively easily separated from the display panel 200 with a relatively small force, at individual portions of the mold frame 301. In addition, in the case where a reworking process of separating only a part of the first, second, third and fourth bent frames 301a, 301b, 301c and 301d from the display panel 200 is carried out, only corresponding one of the plurality of adhesive members 501a, 501b, 501c and 501d may be replaced, and thus the reworking time and the reworking cost may be reduced.

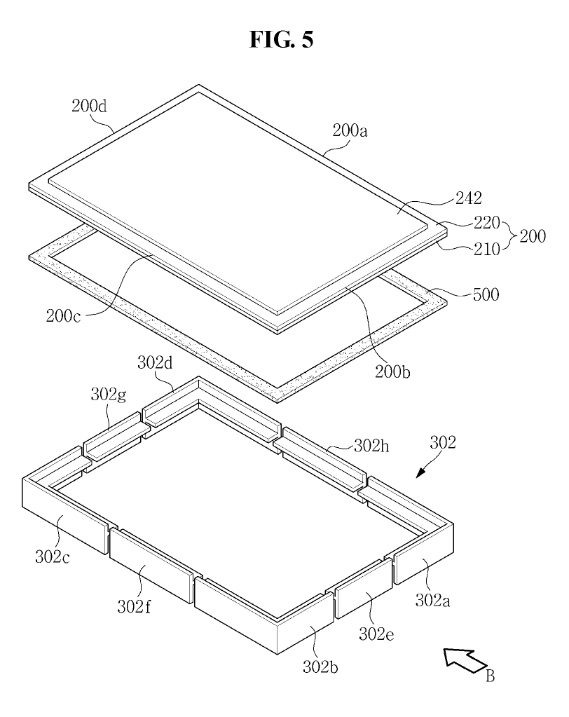

Hereinafter, still another exemplary embodiment will be described with reference to FIG. 5. The descriptions of the same configuration as those of the exemplary embodiment will be omitted for convenience of explanation.

FIG. 5 is an exploded perspective view illustrating still another exemplary embodiment of a display panel, a mold frame and an adhesive member of a display device according to the invention.

Referring to FIG. 5, a mold frame 302 according to still another exemplary embodiment further includes connection frames 302e, 302f, 302g and 302h respectively disposed between two adjacent ones of first, second, third and fourth bent frames 302a, 302b, 302c and 302d.

In specific, the mold frame 302 further includes the first connection frame 302e between the first bent frame 302a and the second bent frame 302b, the second connection frame 302f between the second bent frame 302b and the third bent frame 302c, the third connection frame 302g between the third bent frame 302c and the fourth bent frame 302d, and the fourth connection frame 302h between the fourth bent frame 302d and the first bent frame 302a.

The first connection frame 302e overlaps a part of the second side surface portion 200b of the display panel 200, the second connection frame 302f overlaps a part of the third side surface portion 200c of the display panel 200, the third connection frame 302g overlaps a part of the fourth side surface portion 200d of the display panel 200, and the fourth connection frame 302h overlaps a part of the first side surface portion 200a of the display panel 200. Each of the first, second, third and fourth connection frames 302e, 302f, 302g and 302h, dissimilar to the first, second, third and fourth bent frames 302a, 302b, 302c and 302d, has a straight shape which is not bent in a plane. That is, an entire length of each of the first, second, third and fourth connection frames 302e, 302f, 302g and 302h is extended in one single direction.

As such, as the mold frame 302 according to still another exemplary embodiment further includes the first, second, third and fourth connection frames 302e, 302f, 302g and 302h, each of the first, second, third and fourth bent frames 302a, 302b, 302c and 302d and the first, second, third and fourth connection frames 302e, 302f, 302g and 302h may be relatively easily separated from the display panel 200 even if a relatively small force is applied. Accordingly, each of the first, second, third and fourth bent frames 302a, 302b, 302c and 302d and the first, second, third and fourth connection frames 302e, 302f, 302g and 302h may be relatively easily separated from the display panel 200 without an additional process, e.g., heat application, for substantially preventing damage to the display panel 200.

In other words, as the mold frame 302 includes the first, second, third and fourth bent frames 302a, 302b, 302c and 302d and the first, second, third and fourth connection frames 302e, 302f, 302g and 302h, the reworking time may be substantially minimized and damage to the display panel 200 due to the reworking process may be substantially prevented.

Although one connection frame is further disposed between every two adjacent ones of the bent frames in still another exemplary embodiment, exemplary embodiments are not limited thereto. In an alternative exemplary embodiment, two or more connection frames may be further disposed between every two adjacent ones of the bent frames. That is, as the mold frame 302 is divided into a larger number, the mold frame 302 may be relatively easily separated from the display panel 200 with a relatively smaller force.

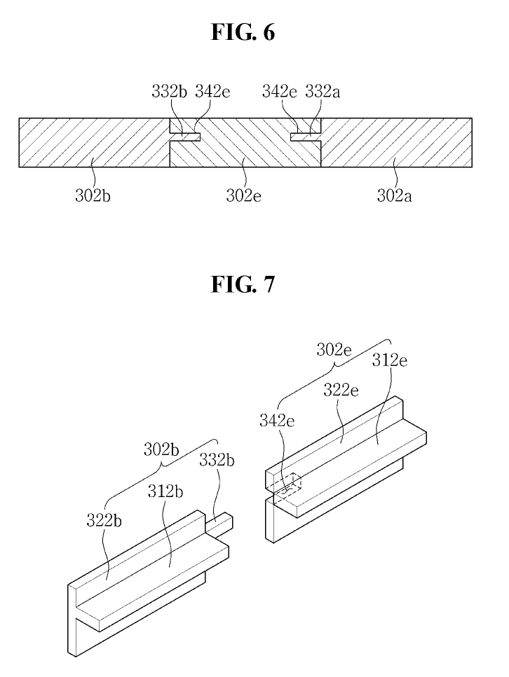

Hereinafter, still another exemplary embodiment will be described with reference to FIGS. 6 and 7. Descriptions of the configurations identical to those of an exemplary embodiment will be omitted for ease of description.

FIG. 6 is a cross-sectional side view illustrating an exemplary embodiment of a mold frame of a display device according to the invention, and FIG. 7 is a perspective view illustrating an exemplary embodiment of a projecting portion and a recessed portion of a mold frame of a display device according to the invention. In specific, FIG. 6 may correspond to a side view viewed from the direction B of FIG. 5.

The first, second, third and fourth bent frames 302a, 302b, 302c and 302d according to still another exemplary embodiment include projecting portions projecting toward respective connection frames 302e, 302f, 302g and 302h adjacent thereto, and the connection frames 302e, 302f, 302g and 302h include recessed portions into which the projecting portions of the bent frames are inserted. In an exemplary embodiment, for example, as illustrated in FIGS. 6 and 7, when a first connection frame 302e is disposed between a first bent frame 302a and a second bent frame 302b which are adjacent to each other, the first bent frame 302a may include a first projecting portion 332a projecting toward the first connection frame 302e, the second bent frame 302b may include a second projecting portion 332b projecting toward the first connection frame 302e, and the first connection frame 302e may include two of a recessed portion 342e into which the first and second projecting portions 332a and 332b are respectively inserted. The projecting portions and recessed portions may be defined by and/or in a respective side surface portion of the connection or bent frame, without being limited thereto. Within a frame, a maximum length of the support portion may correspond to a maximum length of the side surface portion, without being limited thereto.

In particular, referring to FIG. 7, the second bent frame 302b may include a support portion 312b for supporting a display panel 200, a side surface portion 322b bent from the support portion 312b, and the second projecting portion 332b projecting from the side surface portion 322b toward the first connection frame 302e. The first connection frame 302e may include a support portion 312e for supporting the display panel 200, a side surface portion 322e bent from the support portion 312e and a recessed portion 342e defined at the side surface portion 322e into which the second projecting portion 332b is inserted. In addition, although not illustrated, each of the first and second projecting portions 332a and 332b and the recessed portion 342e may be respectively coupled to each other using a hook. The supporting portions of adjacent bent and connection frames joined to each other may be disposed coplanar with each other to support the display panel 200 thereon.

As such, as the projecting portions of the first, second, third and fourth bent frames 302a, 302b, 302c and 302d are inserted into the recessed portions of adjacent ones of the first, second, third and fourth connection frames 302e, 302f, 302g and 302h, respectively, a coupling force between the first, second, third and fourth bent frames 302a, 302b, 302c and 302d and the first, second, third and fourth connection frames 302e, 302f, 302g and 302h may be improved.

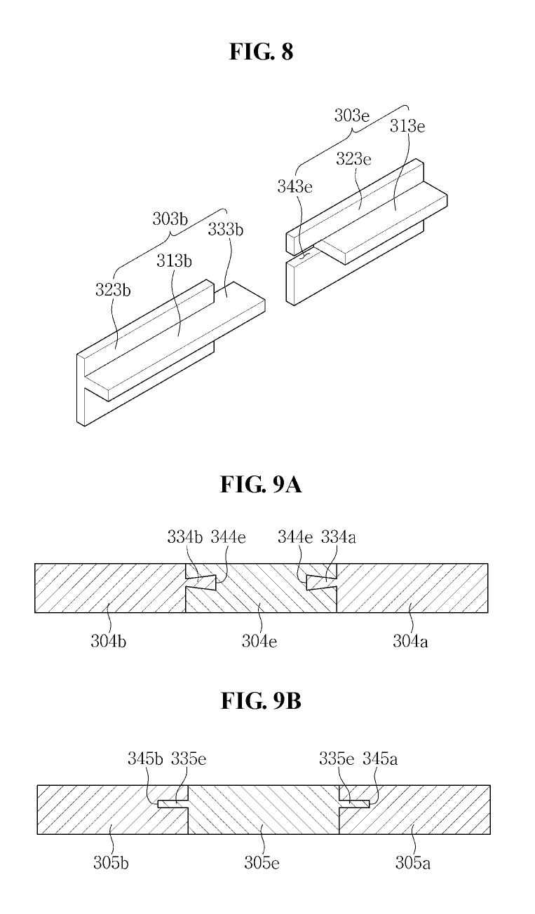

Hereinafter, still another exemplary embodiment will be described with reference to FIG. 8. Descriptions of the configurations identical to those of an exemplary embodiment will be omitted for ease of description.

FIG. 8 is a perspective view illustrating another exemplary embodiment of a projecting portion and a recessed portion of a mold frame of a display device according to the invention.

Referring to FIG. 8, a second bent frame 303b according to still another exemplary embodiment may include a support portion 313b for supporting a display panel 200, a side surface portion 323b bent from the support portion 313b, and a second projecting portion 333b projecting from the side surface portion 323b toward the first connection frame 303e. The first connection frame 303e may include a support portion 313e for supporting the display panel 200, a side surface portion 323e bent from the support portion 313e and a recessed portion 343e defined at the support portion 313e and the side surface portion 323e into which the second projecting portion 333b is inserted. The projecting portions and recessed portions may be defined by and/or in a respective support portion and a side surface portion of the connection or bent frame, without being limited thereto. Within a respective frame, a maximum length of the support portion may be different from a maximum length of the side surface portion, without being limited thereto.

Accordingly, a coupling force between the first and second bent frames 303a and 303b and the first connection frame 303e may be further improved. The above-described structure and coupling of the second bent frame 303b and the first connection frame 303e may be similarly applied to other bent and connection frames described above such that repeated descriptions thereof will be omitted for ease of description.

Hereinafter, still another exemplary embodiment will be described with reference to FIGS. 9A and 9B. Descriptions of the configurations identical to those of an exemplary embodiment will be omitted for ease of description.

FIGS. 9A and 9B are side views illustrating still other exemplary embodiments of a mold frame of a display device according to the invention.

Referring to FIG. 9A, in the case where a first connection frame 304e is disposed between a first bent frame 304a and a second bent frame 304b which are adjacent to each other, the first bent frame 304a may include a first projecting portion 334a projecting toward the first connection frame 304e, the second bent frame 304b may include a second projecting portion 334b projecting toward the first connection frame 304e, and the first connection frame 304e may include two recessed portions 344e into which the first and second projecting portions 334a and 334b are respectively inserted.

In such an exemplary embodiment, the first and second projecting portions 334a and 334b may each have a dovetail cross-sectional shape. Accordingly, a coupling force between the first and second bent frames 304a and 304b and the first connection frame 304e may be further improved.

Referring to FIG. 9B, in the case where a first connection frame 305e is disposed between a first bent frame 305a and a second bent frame 305b which are adjacent to each other, the first connection frame 305e may include two projecting portions 335e respectively projecting toward the first bent frame 305a and the second bent frame 305b, and the first and second bent frames 305a and 305b may include first and second recessed portions 345a and 345b into which the two projecting portions 335e are respectively inserted.

However, exemplary embodiments are not limited thereto, and the shape and position of the plurality of projecting portions and recessed portions may be variously modified.

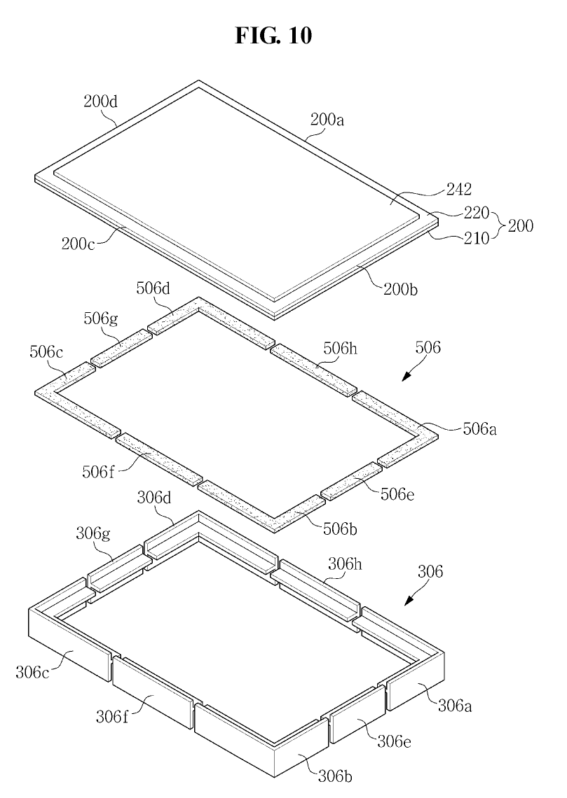

Hereinafter, still another exemplary embodiment will be described with reference to FIG. 10. Descriptions of the configurations identical to those of an exemplary embodiment will be omitted for ease of description.

FIG. 10 is an exploded perspective view illustrating yet another exemplary embodiment of a display panel, a mold frame and an adhesive member of a display device according to the invention.

Referring to FIG. 10, an adhesive member 506 according to still another exemplary embodiment includes a plurality of adhesive members 506a, 506b, 506c, 506d, 506e, 506f, 506g and 506h each corresponding to first, second, third and fourth bent frames 306a, 306b, 306c and 306d and first, second, third and fourth connection frames 306e, 306f, 306g and 306h.

In specific, the adhesive member 506 includes first, second, third and fourth adhesive members 506a, 506b, 506c and 506d which overlap the first, second, third and fourth bent frames 306a, 306b, 306c and 306d, respectively, and have shapes corresponding to shapes of the first, second, third and fourth bent frames 306a, 306b, 306c and 306d, respectively, and further includes fifth, sixth, seventh and eighth adhesive members 306e, 306f, 306g and 306h which overlap the first, second, third and fourth connection frames 306e, 306f, 306g and 306h, respectively, and have shapes corresponding to shapes of the first, second, third and fourth connection frames 306e, 306f, 306g and 306h, respectively,

That is, each of the first, second, third and fourth adhesive members 506a, 506b, 506c and 506d has a shape of “L” on a plane, and each of the fifth, sixth, seventh and eighth adhesive members 306e, 306f, 306g and 306h has a straight shape on a plane. The shape of the individual adhesive members may particularly correspond to the shape of an individual support portion of a respective bent frame or connection frame.

As such, by including the plurality of adhesive members 506a, 506b, 506c, 506d, 506e, 506f, 506g and 506h each corresponding to the first, second, third and fourth bent frames 306a, 306b, 306c and 306d and the first, second, third and fourth connection frames 306e, 306f, 306g and 306h, the mold frame 306 may be relatively easily separated from the display panel 200 with a relatively small force. In addition, when a rework process is performed in which a part of the first, second, third and fourth bent frames 306a, 306b, 306c and 306d and the first, second, third and fourth connection frames 306e, 306f, 306g and 306h are detached from the display panel 200, the reworking time and reworking cost may be reduced by replacing only corresponding ones of the plurality of adhesive members 506a, 506b, 506c, 506d, 506e, 506f, 506g and 506h.

As set forth hereinabove, according to one or more exemplary embodiments, a display device includes a mold frame including a plurality of divided bent frames separable from each other, such that a display panel may be substantially prevented from being damaged during reworking.

While the invention has been illustrated and described with reference to the exemplary embodiments thereof, it will be apparent to those of ordinary skill in the art that various changes in form and detail may be formed thereto without departing from the spirit and scope of the invention.

What is claimed is:

1. A display device comprising:
a display panel which displays an image, the display panel comprising first, second, third and fourth side edge portions which respectively meet each other at corners of the display panel;
a mold frame which is attachable to and detachable from the display panel, the mold frame comprising a plurality of bent frames which are attachable and detachable from each other, each bent frame commonly overlapped by two side edge portions of the display panel which meet each other at a corner thereof; and
an adhesive member disposed commonly between the two side edge portions of the display panel which meet each other at the corner thereof and the bent frame of the mold frame overlapped thereby, to attach the display panel and the mold frame to each other.

2. The display device of claim 1, wherein in a top plan view, each bent frame commonly overlapped by the two side edge portions of the display panel has an “L” shape.

3. The display device of claim 1, wherein in cross-section, each bent frame commonly overlapped by the two side edge portions of the display panel comprises:
a support portion which is commonly overlapped by and supports thereon the two side edge portions of the display panel, and
a side surface portion bent from the support portion.

4. The display device of claim 3, wherein the adhesive member is disposed commonly between the two side edge portions and the support portion overlapped thereby and directly contacts the two side edge portions and the support portion overlapped thereby.

5. The display device of claim 3, wherein
first to fourth bent frames are respectively commonly overlapped by the two side edge portions of the display panel which meet each other at first to fourth corners of the display panel, and
the adhesive member is provided in plurality separable from each other, comprising first to fourth adhesive members respectively commonly between the two side edge portions of the display panel which meet each other at the first to fourth corners of the display panel and the first to fourth bent frames commonly overlapped thereby.

6. The display device of claim 5, wherein in a top plan view, a planar shape of the first to fourth adhesive members is respectively the same as a planar shape of the support portions of the first to fourth bent frames.

7. The display device of claim 1, wherein the adhesive member commonly between the two side edge portions of the display panel which meet each other at the corner thereof and the bent frame of the mold frame overlapped thereby, is a double-sided tape.

8. The display device of claim 7, wherein at least one surface of the double-sided tape comprises at least one of an acrylic resin, an epoxy resin, a fluoro-resin and a polytetrafluoroethylene resin.

9. The display device of claim 1, wherein
a first bent frame and a second bent frame of the mold frame are adjacent to each other,
the first bent frame comprises a projecting portion which projects toward the second bent frame, and
the second bent frame comprises a recessed portion into which the projecting portion of the first bent frame is inserted.

10. The display device of claim 9, wherein the projecting portion of the first bent frame has a dovetail cross-sectional shape.

11. The display device of claim 1, wherein
a first bent frame and a second bent frame of the mold frame are adjacent to each other along a same side edge portion of the display panel, and
the mold frame further comprises a connection frame between the first and second bent frame adjacent to each other to connect the first and second bent frames to each other at the same side edge portion of the display panel.

12. The display device of claim 11, wherein in a top plan view, a length of the connection frame extends in a single direction along the same side edge portion of the display panel.

13. The display device of claim 11, wherein in cross-section each of the first and second bent frames and the connection frame therebetween comprises:
a support portion which supports the display panel thereon, and
a side surface portion bent from the support portion.

14. The display device of claim 13, wherein the adhesive member is commonly disposed between the display panel and the support portions of the first and second bent frames and the connection frame therebetween and directly contacts the display panel and the support portions of the first and second bent frames and the connection frame therebetween.

15. The display device of claim 13, wherein the adhesive member is provided in plurality separable from each other comprising:
a first adhesive member between the display panel and the first bent frame,
a second adhesive member between the display panel and the second bent frame, and
a third adhesive member between the display panel and the connection frame which is between the first and second bent frames.

16. The display device of claim 15, wherein in a top plan view,
a planar shape of each of the first and second adhesive members is respectively the same as a planar shape of the support portions of the first and second bent frames, and
a planar shape of the third adhesive member is the same as a planar shape of the support portion of the connection frame between the first and second bent frames.

17. The display device of claim 11, wherein
the first bent frame or the second bent frame adjacent to each other along the same side edge portion of the display panel comprises a projecting portion which projects toward the connection frame, and
the connection frame between the first and second bent frames comprises a recessed portion into which the projecting portion is inserted.

18. The display device of claim 17, wherein the projecting portion has a dovetail cross-sectional shape.

19. The display device of claim 11, wherein
the connection frame between the first and second bent frames adjacent to each other along the same side edge portion of the display panel comprises a projecting portion which projects toward one of the first bent frame and the second bent frame, and
the one of the first bent frame and the second bent frame comprises a recessed portion into which the projecting portion is inserted.

20. The display device of claim 1, further comprising:
a light source which emits a light to the display panel to display the image;
a light guide plate which guides the light emitted from the light source to the display panel; and
an optical sheet between the light guide plate and the display panel.
